(19) United States
(12) Patent Application Publication
(10) Pub. No.: US 2017/0061872 A1
(43) Pub. Date: Mar. 2, 2017

(54) PIXEL DRIVING CIRCUIT, DRIVING METHOD FOR THE SAME AND DISPLAY DEVICE

(71) Applicant: EVERDISPLAY OPTRONICS (SHANGHAI) LIMITED, Shanghai (CN)

(72) Inventors: Sisi ZHOU, SHANGHAI (CN); Xiaoli XU, SHANGHAI (CN)

(73) Assignee: EVERDISPLAY OPTRONICS (SHANGHAI) LIMITED, SHANGHAI (CN)

(21) Appl. No.: 15/240,110

(22) Filed: Aug. 18, 2016

(30) Foreign Application Priority Data
Aug. 31, 2015 (CN) 201510548838.9

(51) Int. Cl. G09G 3/3225

(52) U.S. Cl. CPC G09G 3/3225; G09G 2320/0666; G09G 2310/08

(57) ABSTRACT

The present disclosure relates to a pixel driving circuit, a driving method for the pixel driving circuit and a display device. The pixel driving circuit includes: a source driving circuit providing data signals to each of the sub-pixels in a pixel array; and a gate driving circuit providing gate scan signals to each of the sub-pixels in the pixel array; wherein the gate driving circuit provides the gate scan signals at different timings to a plurality of sub-pixels in a repeating unit of the pixel array, respectively, and the repeating unit includes at least one pixel unit including adjacent sub-pixels of different colors in the same row.

### CROSS-REFERENCE TO RELATED APPLICATIONS

This application is based upon and claims priority to Chinese Patent Application No. 201510548838.9, filed Aug. 31, 2015, the entire contents of which are incorporated herein by reference.

### TECHNICAL FIELD

The present disclosure generally relates to the display technical field, and more particularly, to a pixel driving circuit, a driving method for the pixel driving circuit and a display device.

### BACKGROUND

In display devices, sub-pixel units are defined by gate scan lines and data lines which are perpendicular with each other. A plurality of data lines and gate scan lines define a pixel array which includes a plurality of sub-pixel units arranged in a matrix. The gate scan lines provide gate scan signals to the pixel units. For example, when a gate scan signal is at a high level, the pixel units corresponding to the gate scan line are turned on, and data signals provided by the data lines are written.

A commonly used Organic Light Emitting Diode (OLED) driving circuit is as shown in FIG. 1. The circuit includes a switching transistor T1, a driving transistor T2, a compensation transistor T3, isolation transistors T4 and T5, a reset transistor T6 and a storage capacitor Cst. There may be one or more than one compensation transistor T3 and reset transistor T6 in the circuit. For example, the number of the compensation transistor T3 or the reset transistor T6 is one, as shown in FIG. 1. The circuit in FIG. 1 further includes gate scan signals Sn, Sn−1, and Sn−2, an enable signal En, a power supply voltage ELVDD, a low voltage ELVSS, and an initialization signal Vint. For the circuit in FIG. 1, when a source driving circuit provides data signals to the pixel array, a data signal driver (i.e., a data signal driving circuit, “Data IC” for short) is generally used for the purpose of providing a plurality of data signals to the pixel array by one data line. Thus, the number of Data ICs is reduced, and thereby costs are lowered. The structure schematic of the data signal driver is shown in FIG. 2. In conventional technologies, switches and control signals SWs are usually used to control the operation time sequence of plurality of data signals in Data ICs. As shown in FIG. 2, for example, one Data IC provides six data signals (i.e., data signals D1˜D6) by one data line. Whether the six data signals can provide data voltages to corresponding sub-pixels is controlled by control signals SW1˜SW6 and corresponding switches. FIG. 3 is a schematic diagram showing waveforms (levels) of a gate scan signal Sn and control signals SW1˜SW6. As can be seen from FIG. 3, when the gate scan signal Sn is at a low level, there may be more than one control signal at a low level, for example, the control signal SW1 for controlling D1 and the control signal SW6 for controlling D6. When the gate scan signal Sn is at the low level, a transistor T1 is turned on. When the data signal D1 is written, the gate scan signal Sn is at the low level, and the transistors T1 in the row corresponding to the gate scan signal Sn are all turned on. That is to say, in addition to the turning-on of the switches corresponding to D1, other switches are also turned on in advance. However, in this row, except that the data voltage of D1 is written, other data voltages (D2˜D6) are not written yet, and if writing is performed at this time, the previous data voltages will be written in. As a result, the sub-pixel corresponding to D1 is written with normal data voltage, while the sub-pixels corresponding to D2˜D6 are written with wrong data voltages.

As explained above, the sub-pixels corresponding to D2˜D6 are written with wrong data voltages at this time, and when the wrong data voltages are higher than the right data voltages which shall be provided by the data signal driver, the right data voltages cannot be written into the sub-pixels, because the transistor T2 is a PMOS transistor, and the gate voltage of T2 is higher than the data voltages, resulting in that the transistor T2 is turned off and corresponding sub-pixel cannot be charged. In conclusion, if the transistors in one row corresponding to the gate scan signal Sn are all turned on, displaying problem will occur during the brightness switching of a display from black to white due to the influence of the data signals retained in the previous frame on the writing of the data signals in the current frame.

### SUMMARY

Aiming at the problem with conventional technologies, the present disclosure provides a pixel driving circuit, a driving method for the pixel driving circuit and a display device, in order to solve the problem that switching transistors are turned on before current data signals are written and thus wrong data voltages are written into sub-pixels, and consequently the switching transistors are non-conducted and corresponding sub-pixel cannot be charged.

In order to achieve the above objective, according to an aspect of embodiments of the present disclosure, there is provided a pixel driving circuit for driving a pixel array including sub-pixels arranged in rows and columns, wherein the pixel driving circuit includes:

a source driving circuit providing data signals to each of the sub-pixels in the pixel array; and

a gate driving circuit providing gate scan signals to each of the sub-pixels in the pixel array;

wherein the gate driving circuit provides the gate scan signals at different timings to the sub-pixels in a repeating unit of the pixel array, respectively, and the repeating unit includes at least one pixel unit including adjacent sub-pixels of different colors in the same row.

According to an embodiment of the present disclosure, the pixel driving circuit further includes:

a plurality of data signal drivers disposed between the source driving circuit and the pixel array, each of the plurality of data signal drivers having an input terminal and an output terminal;

wherein the input terminal of each of the plurality of data signal drivers is connected to the source driving circuit via a source line, and the output terminal of each of the plurality of data signal drivers is connected to the sub-pixels in the pixel array via data lines to transmit the plurality of data signals to the sub-pixels at different timings.

According to an embodiment of the present disclosure, the pixel driving circuit further includes:

a timing control circuit providing data switching signals to the plurality of data signal drivers;

wherein each of the plurality of data signal drivers further has a control terminal connected to the timing control circuit, and whether the output terminals of the data signal drivers output the data signals or not is determined by the data switching signals input at the control terminals of the plurality of data signal drivers.

According to an embodiment of the present disclosure, each of the data signal drivers includes:

a multiplexer having an input terminal connected to the source line and a plurality of output terminals; and

a plurality of first switching elements, each of which has an input terminal connected to a corresponding output terminal of the multiplexer, a control terminal receiving a corresponding data switching signal, and an output terminal connected to a corresponding data line to transmit the data signals to sub-pixels in the pixel array via the data line.

According to an embodiment of the present disclosure, the pixel unit includes M sub-pixels, and the gate driving circuit provides N gate scan signals to N sub-pixels in the repeating unit at different timings, respectively, where M and N are positive integers, and N is an integral multiple of M.

According to an embodiment of the present disclosure, the N gate scan signals are generated by N gate drivers, respectively, and an output terminal of any one of the N gate drivers outputs one of the gate scan signals.

According to an embodiment of the present disclosure, the N gate scan signals are generated by a gate scan signal generation circuit which includes:

a gate driver having an input terminal and N output terminals; and

N second switching elements, each of which has an input terminal connected to a corresponding output terminal of the gate driver, a control terminal receiving a scan switching signal, and an output terminal outputting a corresponding one among the gate scan signals under the control of the scan switching signal.

According to another aspect of embodiment of the present disclosure, there is provided a driving method for a pixel driving circuit, wherein the pixel driving circuit is configured to drive a pixel array including sub-pixels arranged in rows and columns and includes:

a source driving circuit providing data signals to each of the sub-pixels in the pixel array; and

a gate driving circuit providing gate scan signals to each of the sub-pixels in the pixel array;

wherein switching transistors are disposed in the sub-pixels, each of the switching transistors has a control terminal receiving a corresponding gate scan signal via a gate scan line and a data terminal receiving a corresponding data signal via a data line;

wherein the method includes:

turning on (for example, individually turning on) the switching transistors in the sub-pixels in a repeating unit of the pixel array at different time periods under the control of the gate scan signals at different timings, wherein the repeating unit includes at least one pixel unit including adjacent sub-pixels of different colors in the same row; and

when the switching transistors are turned on, transmitting the data signals to the sub-pixels where the switching transistors are located.

According to another embodiment of the present disclosure, the gate scan signals at different timings are generated by a plurality of gate drivers, respectively.

According to another embodiment of the present disclosure, the gate scan signals at different timings are generated by a gate scan signal generation circuit, wherein the gate scan signal generation circuit includes a gate driver and a plurality of switching elements which output the gate scan signals under the control of scan switching signals.

According to another aspect of embodiments of the present disclosure, there is provided a display device including a pixel array and the above pixel driving circuit for driving the pixel array.

The technical solutions of the present disclosure at least have the following advantageous effects:

In conventional technologies, sub-pixels in the same row are controlled by the same gate scan signal, and when the switching transistor of one of the sub-pixels is turned on, the switching transistors of other sub-pixels in the same row are turned on before the current data signals are written. In the present disclosure, sub-pixels in the same row are provided with gate scan signals at different timings (i.e., gate scan signals having different time sequences), and thus the present disclosure can solve the above problem with conventional technologies.

### BRIEF DESCRIPTION OF THE DRAWINGS

FIG. 1 is a schematic diagram showing an OLED pixel driving circuit in conventional technologies.

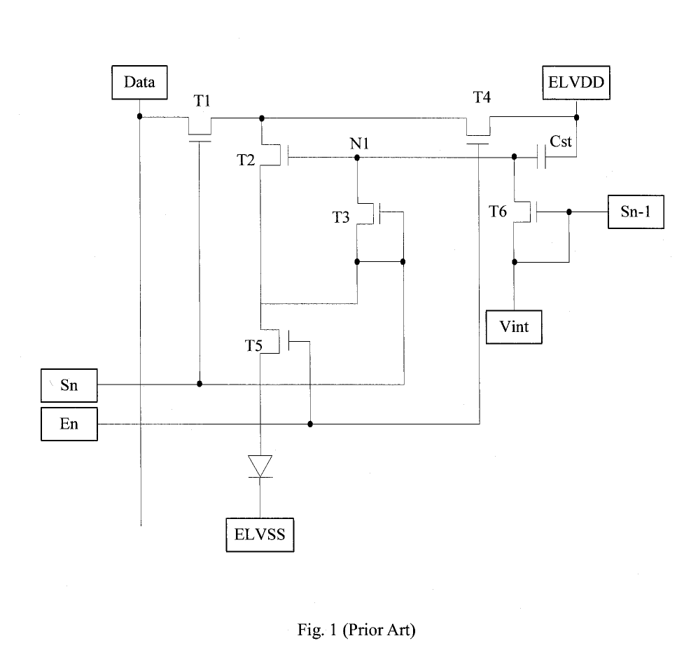

FIG. 2 is a schematic diagram showing a structure of a data signal driver in conventional technologies.

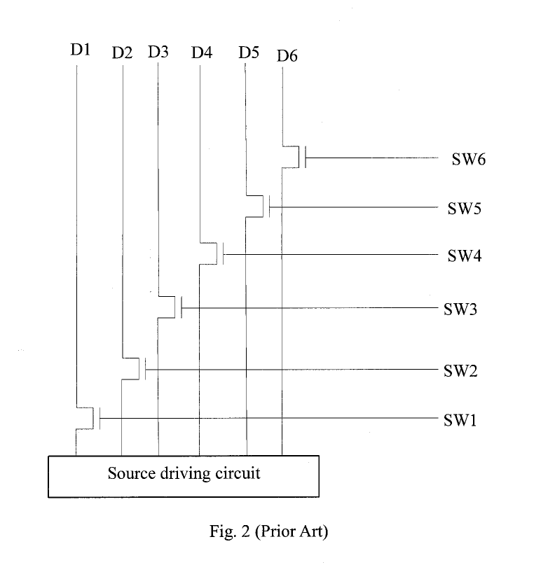

FIG. 3 is a schematic diagram showing waveforms of a gate scan signal and control signals in FIG. 2.

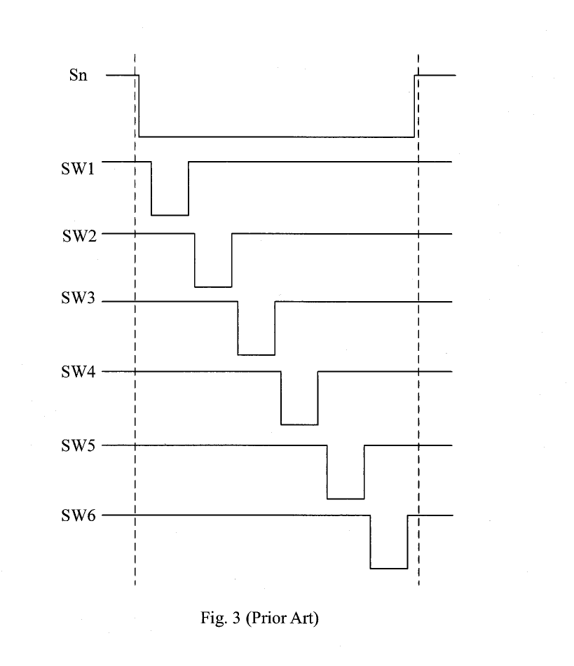

FIG. 4 is a schematic diagram showing a structure of a pixel driving circuit according to an embodiment of the present disclosure.

FIG. 5 is a schematic diagram showing a structure of a data signal driver in a pixel driving circuit according to an embodiment of the present disclosure.

FIG. 6 is a timing chart showing waveforms of data switching signals according to an embodiment of the present disclosure.

FIG. 7 is a circuit diagram illustrating a case where six gate scan signals are generated by six gate drivers, respectively according to an embodiment of the present disclosure.

FIG. 8 is a circuit diagram illustrating a case where six gate scan signals are generated by a gate driver according to an embodiment of the present disclosure.

FIG. 9 is a schematic diagram showing a pixel circuit structure of any one of six sub-pixels Pixels 1˜6 according to another embodiment of the present disclosure.

FIG. 10 is a schematic diagram showing a pixel driving circuit according to another embodiment of the present disclosure.

FIG. 11 is a schematic diagram showing waveforms of gate scan signals and control signals in FIG. 10.

FIG. 12 is a flowchart showing a driving method for a pixel driving circuit according to another embodiment of the present disclosure.

### DETAILED DESCRIPTION

Typical embodiments presenting features and advantages of the present disclosure will be described below in detail. It shall be understood that the present disclosure can have various modifications in different embodiments without departing the scope of the present disclosure. The description and the accompanying drawings are only for the illustrative purpose but not for limiting the present disclosure.

In order to solve the previously-mentioned problem, some embodiments are provided to explain and describe the present disclosure.

### First Embodiment

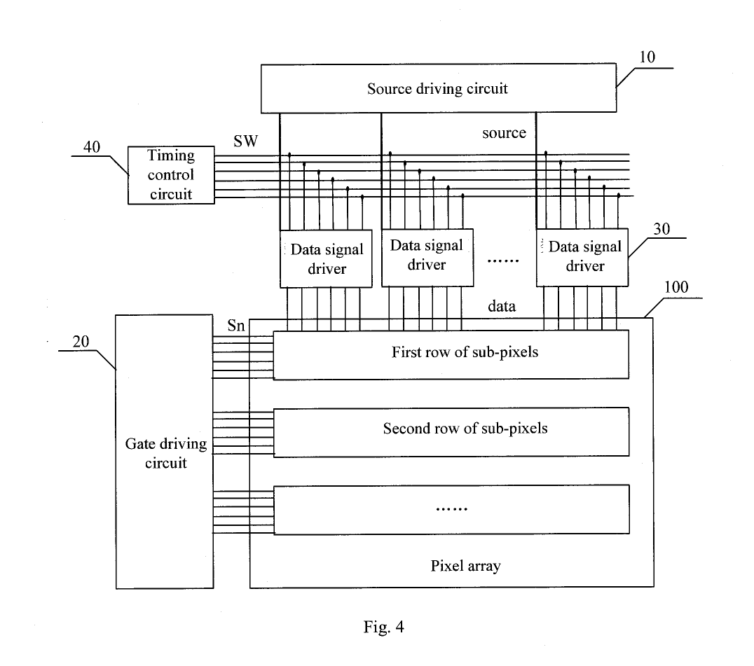

The embodiment provides a pixel driving circuit for driving a pixel array 100. The pixel array 100 includes a plurality of sub-pixels arranged in rows and columns. FIG. 4 is a schematic diagram showing a structure of the pixel driving circuit. The pixel driving circuit includes a source driving circuit 10 and a gate driving circuit 20.

The source driving circuit 10 provides data signals to each of the sub-pixels in the pixel array 100.

The gate driving circuit 20 provides gate scan signals to each of the sub-pixels in the pixel array 100. Specifically, the gate driving circuit 20 provides the gate scan signals at different timings to a plurality of sub-pixels in a repeating unit of the pixel array 100, respectively. The repeating unit includes at least one pixel unit including adjacent sub-pixels of different colors in the same row.

Referring to FIG. 4, the main difference between the pixel driving circuit in the embodiment and the conventional pixel driving circuit resides in that sub-pixels in the same row need to be driven by gate scan signals at different timings. In the embodiment, different gate scan signals are provided to sub-pixels of different colors in one pixel unit, instead of providing the same gate scan signal as the conventional technologies. Specifically, in the pixel driving circuit, when a gate scan signal enables switching transistors in corresponding sub-pixels to be turned on (i.e., conducted), the switching transistors in other sub-pixels controlled by other gate scan signals are still in a turned-off state (i.e., not conducted), and thus the embodiment can avoid the problem with the conventional technologies that the switching transistors of other sub-pixels are turned on in advance when the current data signals are not written. Consequently, the influence of data signals in the previous frame on the writing of the data signals into the sub-pixels in the current frame can be eliminated.

It shall be noted that the source driving circuit 10 is usually disposed at an upper edge or a lower edge of the pixel array 100, and the gate driving circuit 20 is usually disposed at a left edge or a right edge of the pixel array 100. For the situation where the number of the sub-pixels in the horizontal direction is far greater than the number of the sub-pixels in the vertical direction, gate driving circuits are usually disposed at both the left and right edges of the pixel array 100. Specific arrangement may be designed according to actual requirements and detailed descriptions are not elaborated herein.

In an embodiment, the pixel driving circuit may further include a plurality of data signal drivers 30. The plurality of data signal drivers 30 are disposed between the source driving circuit 10 and the pixel array 100 and each has an input terminal and an output terminal. The input terminal of each data signal driver 30 is connected to the source driving circuit 10 via a source line Source, and the output terminal of each data signal driver 30 is connected to the sub-pixels in the pixel array 100 via data lines Data to transmit the data signals to the sub-pixels at different timings.

Each of the data signal driving circuits 30 outputs data signals using one source line Source and a plurality of data lines Data for driving the plurality of sub-pixels in the display region. Thus, the number of the ICs is greatly reduced and thereby the IC costs are lowered.

In an embodiment, the pixel driving circuit may further include a timing control circuit 40 for providing data switching signals SWs to the data signal drivers 30.

Each of the data signal drivers 30 further has a control terminal connected to the timing control circuit 40, and whether the output terminals of the data signal drivers 30 output the data signals is determined by the data switching signals SWs input at the control terminals of the data signal drivers 30.

The pixel driving circuit includes both the data signal drivers 30 and the timing control circuit 40 so as to provide enabling signals (i.e., the above data switching signals SWs) having timing features which are capable of controlling the data signal drivers 30 to provide the data signals to the pixel array.

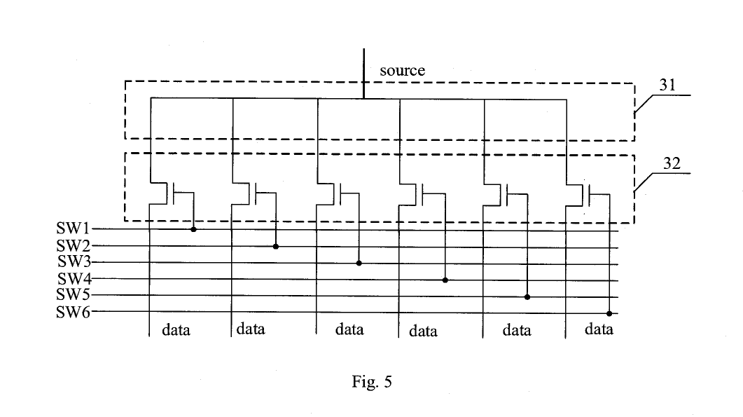

FIG. 5 is a schematic diagram showing a structure of one of the data signal drivers 30. The data signal driver 30 includes a multiplexer 31 and a plurality of first switching elements 32.

The multiplexer 31 has an input terminal connected to the source line Source and a plurality of output terminals.

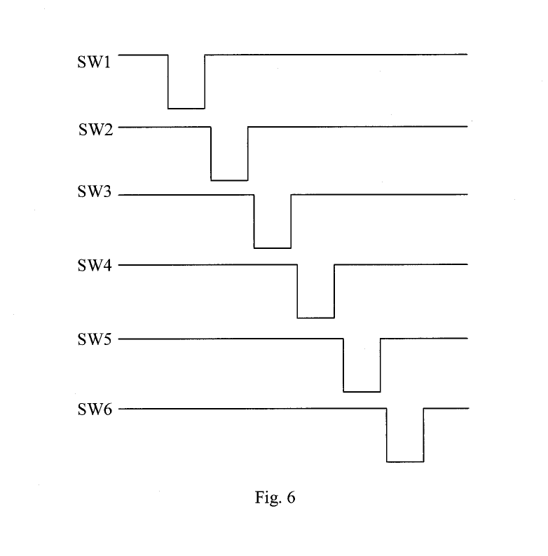

Each of the first switching elements 32 has an input terminal connected to a corresponding output terminal of the multiplexer, a control terminal receiving a corresponding data switching signal SW, and an output terminal connected to a corresponding data line Data to transmit the data signals to sub-pixels in the pixel array via the data line. The data switching signals SWs are provided by the timing control circuit 40. FIG. 6 is a timing chart showing waveforms of data switching signals SWs in FIG. 5, in which a low level occurs in SW1˜SW6 sequentially.

A pixel unit may include a gate driving circuit 20 for M sub-pixels of different colors. The gate driving circuit 20 provides N gate scan signals to N sub-pixels in repeating units at different timings, respectively, where M and N are positive integers, and N is an integral multiple of M. Generally, M is equal to three, that is, each pixel unit includes sub-pixels of three colors, i.e., red, green and blue. Correspondingly, the gate driving circuits 20 provide gate scan signals to the three sub-pixels in the pixel unit at different timings. If one repeating unit includes two pixel units, the repeating unit includes six sub-pixels, and thus it is needed to provide six gate scan signals at different timings to the repeating unit.

It shall be noted that the N gate scan signals having different time sequences provided by the gate driving circuits 20 may be generated by the following two approaches.

In a first approach, the N gate scan signals are generated by N gate drivers, respectively, and an output terminal of any one of the N gate drivers is connected to a gate scan line.

In a second approach, the N gate scan signals are generated by a gate scan signal generation circuit which includes a gate driver and N second switching elements.

The gate driver has an input terminal and N output terminals.

Each of the N second switching elements has an input terminal connected to the output terminal of the gate driver, a control terminal receiving a scan switching signal and an output terminal outputting a corresponding one among the gate scan signals Sn1˜SnN under the control of the scan switching signal.

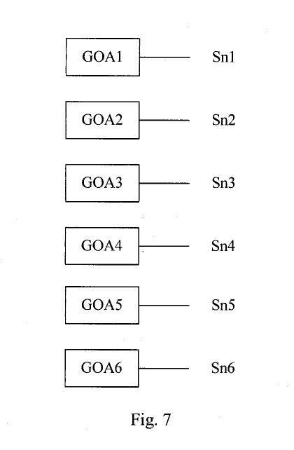

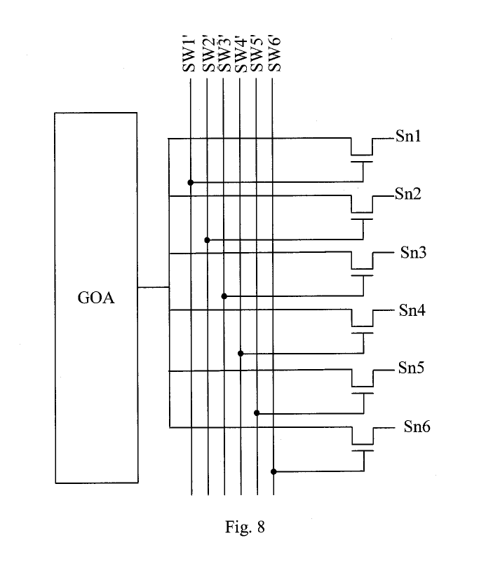

For example, N is equal to six in the embodiment. According to the first approach, the six gate scan signals are generated by six gate drivers, respectively, as shown in FIG. 7. Generally, the gate drivers employ a Gate Driver On Array (GOA) technology, that is, six GOAs generate six gate scan signals Sn. According to the second approach, the six gate scan signals are generated by one gate driver, as shown in FIG. 8. In addition to one gate driver, six switching elements are connected to the output terminal of the gate driver. The control terminals of the six switching elements receive six control signals (i.e., scan switching signals SW1′˜SW6′), respectively, and output the gate scan signals Sn1˜Sn6 under the control of the scan switching signals SW1′˜SW6′.

In view of the above, in the pixel driving circuit provided by the present embodiment, different gate scan signals are provided to sub-pixels in the same row at different timings. Thus, the embodiment can solve the problem with conventional technologies that sub-pixels in the same row are controlled by the same gate scan signal, and when the switching transistor of one of the sub-pixels is turned on, the switching transistors of other sub-pixels in the same row are turned on before the current data signals are written. Further, the data signal driver can drive multiple sub-pixels using one source line, and thereby costs are lowered.

### Second Embodiment

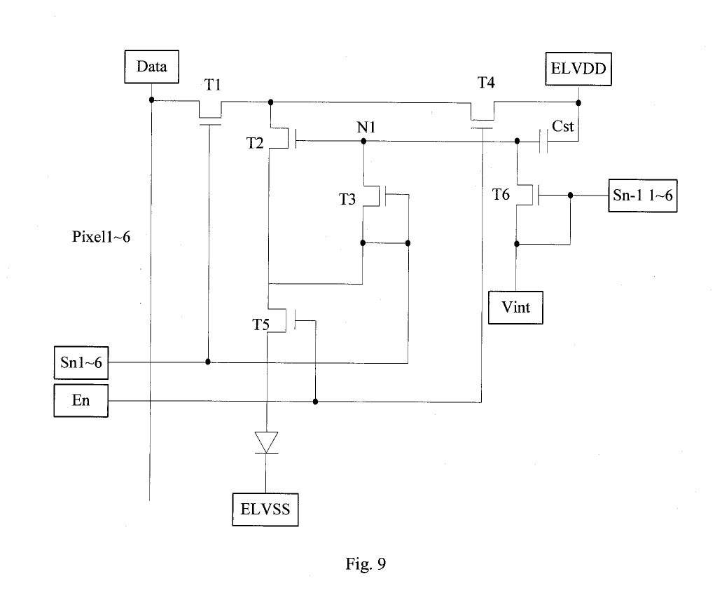

FIG. 9 is a schematic diagram showing a pixel circuit structure of any one of six sub-pixels Pixels 1˜6 according to another embodiment of the present disclosure. The differences between the pixel circuit in the present embodiment and the pixel circuit in conventional technologies are as follows. In the embodiment, three sub-pixels constitute a pixel unit, and two such pixel units make up a repeating unit. The gate scan signals Sns for the six sub-pixels are Sn1, Sn2, Sn3, Sn4, Sn5 and Sn6. These gate scan signals are provided to the gates of the switching transistors T1 and the gates of the compensate transistors T3, respectively. For example, when the gates of T1 and T3 are provided with Sn2, the gate of the reset transistor T6 is provided by the gate scan signal (Sn1) in the previous frame, and the like.

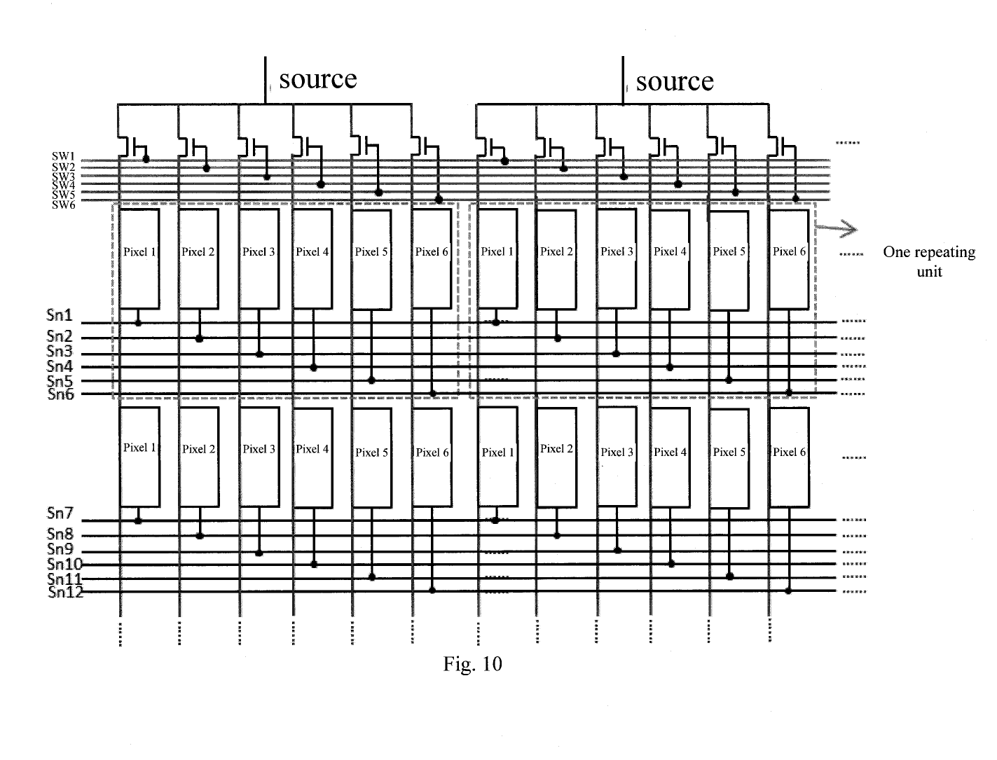

FIG. 10 is a schematic diagram showing a pixel driving circuit according to an embodiment of the present disclosure. For example, N is equal to six, and M is equal to three. Referring to FIG. 10, the source signal on one source line Source is fanoutted into six data lines Data each of which is connected to one switching element, and then the source signal is transmitted to a column of sub-pixels. The Pixel 1, Pixel 2, Pixel 3 in FIG. 10 are a red sub-pixel R, a green sub-pixel G and a blue sub-pixel B, respectively. For the first row of sub-pixels, Sn1 is provided to Pixel 1, Sn2 is provided to Pixel 2, Sn3 is provided to Pixel 3, Sn4 is provided to Pixel 4, Sn5 is provided to Pixel 5, and Sn6 is provided to Pixel 6. When Sn1 enables the switching transistor of Pixel 1 to be turned on, the data switching signal SW1 enables the corresponding switching element (usually a transistor TFT) to be turned on, the data signal Data is written into Pixel 1, and the switching transistors of other five pixels are not turned on at this time; when Sn2 enables the TFT of Pixel 2 to be turned on, the data switching signal SW2 enables the corresponding switching element to be turned on, the data signal Data is written into Pixel 2, and TFTs of other five pixels are not turned on at this time, and the like. Thus, the present embodiment does not encounter with the problem as conventional technologies that transistors (TFTs) are turned on in advance before the current data signals are written.

The circuit in FIG. 10 further includes gate scan signals Sn7˜Sn12 for controlling on and off of the switching transistors of the sub-pixels in the second row. Specifically, when the switching transistors are turned on, corresponding data signals are written. The principles are the same and detailed description is not elaborated herein.

It shall be noted that the present embodiment is described with an example where the sub-pixels of commonly used three colors include a red sub-pixel R, a green sub-pixel G and a blue sub-pixel B, and in actual application, in addition to the sub-pixels of the three basic colors, sub-pixels of white color may be used to form a pixel unit with the sub-pixels of the three colors (RGBW). Or, sub-pixels of yellow color may be used to form a pixel unit with the sub-pixels of the three colors (RGBY), and then M is equal to four, and N is an integral multiple of M. If one repeating unit includes two pixel units, eight gate scan signals are needed. For example, if each pixel unit includes sub-pixels of red, green, blue and white, the number of the data signals provided by each data signal driver via one source line Source, the number of the required data switching signals and the number of the switching elements in the data signal drivers need to be adaptively adjusted, and detailed description is omitted herein.

It shall be noted that one source line provides six data signals for driving six sub-pixels in the same row in the present embodiment, and alternatively, the one source line can provide n data signals for driving n sub-pixels, where n is equal to or greater than 2, and meanwhile each of the n sub-pixels is provided with one gate scan signal Sn. No matter how many data signals are provided by one source line, the number of the sub-pixels in one repeating unit, the number of the gate scan signals and the number of the data signals provided by one source line shall be consistent with each other.

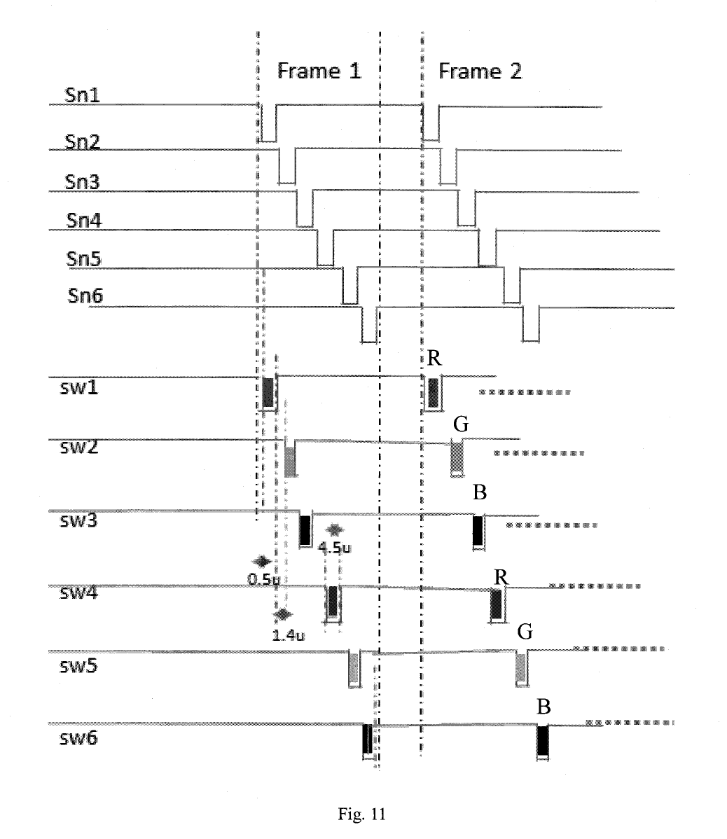

FIG. 11 is a schematic diagram showing waveforms of gate scan signals and data switching signals in FIG. 10. A high level (usually 5.5V˜7.5V) in the waveforms corresponds to the ELVDD in FIG. 10, and a low level (usually −7V˜9V) in the waveforms corresponds to the ELVSS in FIG. 10. For example, the gate scan signals Sn1˜Sn6 are at a low level in sequence in the first frame (Frame 1). When Sn1 is at a low level, the switching transistor in Pixel 1 is turned on, the data switching signal SW1 for controlling providing of a data signal to Pixel 1 is at a low level, the switching element controlled by SW1 is turned on at this time, and the data signal is written into Pixel 1; when Sn2 is at a low level, the switching transistor in Pixel 2 is turned on, the data switching signal SW2 for controlling providing of a data signal to Pixel 2 is at a low level, the switching element controlled by SW2 is turned on at this time, and the data signal is written into Pixel 2 . . . , and the like. The gate scan signals Sn1˜Sn6 are at a low level in sequence in the second frame (Frame 2). The principle and waveforms are the same as those in the first frame and repeated descriptions are omitted herein. It shall be further noted that Sn1˜Sn6 provide a low level in sequence, and SW1˜SW6 provide a low level in sequence. When SW1 and Sn1 are at a low level, the data signal for Pixel 1 (the R sub-pixel) is written. When SW2 and Sn2 are at a low level, the data signal for Pixel 2 (the G sub-pixel) is written. When SW3 and Sn3 are at a low level, the data signal for Pixel 3 (the B sub-pixel) is written. When SW4 and Sn4 are at a low level, the data signal for Pixel 4 (the R sub-pixel) is written. When SW5 and Sn5 are at a low level, the data signal for Pixel 5 (the G sub-pixel) is written. When SW6 and Sn6 are at a low level, the data signal for Pixel 6 (the B sub-pixel) is written.

It shall be noted that, the low level occurs in Sn˜Sn6 in sequence, that is to say, the falling edge at the start of the low level in Sn2 corresponds to the rising edge at the end of the low level in Sn1. However, the data switching signals SWs are different. Referring to FIG. 11, the falling edge at the start of the low level in SW1 is about 0.5 μs delayed with respect to the falling edge at the start of the low level in Sn1, the pulse width of the low level in the SW1 is smaller than the pulse width of the low level in Sn1, about 4.5 μs, and there is a gap of about 1.4 μs between the falling edge at the start of the low level in SW2 and the rising edge at the end of the low level in SW1, unlike Sn2 and Sn1 in which the falling edge at the start of the low level in Sn2 corresponds to the rising edge at the end of the low level in Sn1.

In view of the above, the embodiment can solve the technical problem solved by the first embodiment and achieve the same technical effects, i.e., the present embodiment can solve the problem that the data signals in the previous frame influence the pixels in the current frame when one source line drives multiple sub-pixels.

### Third Embodiment

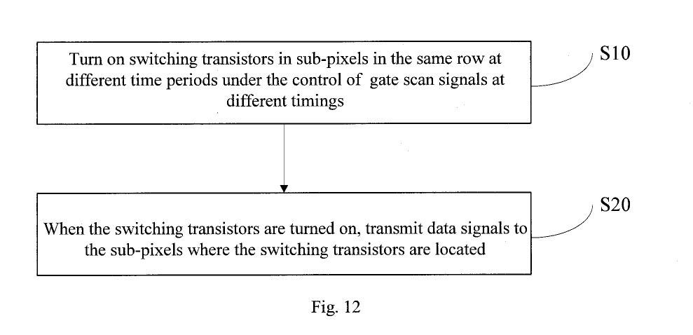

The present embodiment provides a driving method for a pixel driving circuit. The pixel driving circuit is configured to drive a pixel array including sub-pixels arranged in rows and columns and includes a source driving circuit and a gate driving circuit. The source driving circuit provides data signals to each of the sub-pixels in the pixel array. The gate driving circuit provides gate scan signals to each of the sub-pixels in the pixel array. Switching transistors are disposed in the sub-pixels. Each of the switching transistors has a control terminal receiving a corresponding gate scan signal via a gate scan line and a data terminal receiving a corresponding data signal via a data line. The flowchart of the steps of the driving method is as shown in FIG. 12. The method includes the following steps.

In step S10, the switching transistors in sub-pixels in a repeating unit of the pixel array are turned on at different time periods under the control of the gate scan signals at different timings.

In step S20, when the switching transistors are turned on, the data signals are transmitted to the sub-pixels where the switching transistors are located.

The repeating unit includes at least one pixel unit including adjacent sub-pixels of different colors in the same row.

In step S10, the gate scan signals at different timings may be generated by a plurality of gate drivers, respectively, as shown in the circuit in FIG. 6.

Alternatively, in step S10, the gate scan signals at different timings may be generated by a gate driver and a plurality of switching elements which output the gate scan signals under the control of scan switching signals, as shown in the circuit in FIG. 7.

Taking the pixel driving circuit in FIG. 10 as an example, the transmitting the data signals to the sub-pixels where the switching transistors are located in step S20 may be implemented as follows:

When the gate scan signal Sn1 is at a low level, the timing control circuit outputs a data switching signal SW1 at a low level, the switching element in the data signal driver is turned on, and the data signal is provided to the sub-pixel Pixel 1 controlled by Sn1. Since Sn1 is at a low level, the switching transistor in Pixel 1 is turned on, and the data signal can be written into the sub-pixel Pixel 1. Data signals may be written into other sub-pixels similarly.

In the driving method provided by the present disclosure, the writing of data of sub-pixels in the same row is controlled using different gate scan signals at different timings. Thus, the method can solve the problem with conventional technologies that sub-pixels in the same row are controlled by the same gate scan signal, and when the switching transistor of one of the sub-pixels is turned on, the switching transistors of other sub-pixels in the same row are turned on before the current data signals are written. Further, the data signal driver can drive multiple sub-pixels using one source line, and thereby costs are lowered.

### Fourth Embodiment

The embodiment further provides a display device which may include a pixel array and the pixel driving circuit as provided in the above first and second embodiments for driving the pixel array.

One of ordinary skill in this art will appreciate that modifications and substitutions made without departing from the scope and spirit of the present disclosure as defined by appending claims shall fall within the protection scope of the claims the present disclosure.

What is claimed is:

1. A pixel driving circuit for driving a pixel array comprising sub-pixels arranged in rows and columns, wherein the pixel driving circuit comprises:
a source driving circuit providing data signals to each of the sub-pixels in the pixel array; and
a gate driving circuit providing gate scan signals to each of the sub-pixels in the pixel array;
wherein the gate driving circuit provides the gate scan signals at different timings to the sub-pixels in a repeating unit of the pixel array, respectively, and the repeating unit comprises at least one pixel unit comprising adjacent sub-pixels of different colors in the same row.

2. The pixel driving circuit according to claim 1, further comprising:
a plurality of data signal drivers disposed between the source driving circuit and the pixel array, each of which has an input terminal and an output terminal;
wherein the input terminal of each of the plurality of data signal drivers is connected to the source driving circuit via a source line, and the output terminal of each of the plurality of data signal drivers is connected to the sub-pixels in the pixel array via data lines to transmit the data signals to the sub-pixels at different timings.

3. The pixel driving circuit according to claim 2, further comprising:
a timing control circuit providing data switching signals to the data signal drivers;
wherein each of the plurality of data signal drivers further has a control terminal connected to the timing control circuit, and whether the output terminals of the data signal drivers output the data signals or not is determined by the data switching signals input at the control terminals of the plurality of data signal drivers.

4. The pixel driving circuit according to claim 3, wherein each of the data signal drivers comprises:
a multiplexer having an input terminal connected to the source line and a plurality of output terminals; and
a plurality of first switching elements, each of which has an input terminal connected to a corresponding output terminal of the multiplexer, a control terminal receiving a corresponding data switching signal, and an output terminal connected to a corresponding data line to transmit the data signals to sub-pixels in the pixel array via the data line.

5. The pixel driving circuit according to claim 1, wherein the pixel unit comprises M sub-pixels, and the gate driving circuit provides N gate scan signals to N sub-pixels in the repeating unit at different timings, respectively, where M and N are positive integers, and N is an integral multiple of M.

6. The pixel driving circuit according to claim 5, wherein the N gate scan signals are generated by N gate drivers, respectively, and an output terminal of any one of the N gate drivers outputs one of the gate scan signals.

7. The pixel driving circuit according to claim 5, wherein the N gate scan signals are generated by a gate scan signal generation circuit which comprises:
a gate driver having an input terminal and N output terminals; and
N second switching elements, each of which has an input terminal connected to a corresponding output terminal of the gate driver, a control terminal receiving a scan switching signal, and an output terminal outputting a corresponding one among the gate scan signals under the control of the scan switching signal.

8. A driving method for a pixel driving circuit, wherein the pixel driving circuit is configured to drive a pixel array comprising sub-pixels arranged in rows and columns and comprises:
a source driving circuit providing data signals to each of the sub-pixels in the pixel array; and
a gate driving circuit providing gate scan signals to each of the sub-pixels in the pixel array;
wherein switching transistors are disposed in the sub-pixels, each of the switching transistors has a control terminal receiving a corresponding gate scan signal via a gate scan line and a data terminal receiving a corresponding data signal via a data line;
wherein the method comprises:
turning on the switching transistors in the sub-pixels in a repeating unit of the pixel array at different time periods under the control of the gate scan signals at different timings, wherein the repeating unit comprises at least one pixel unit comprising adjacent sub-pixels of different colors in the same row; and
when the switching transistors are turned on, transmitting the data signals to the sub-pixels where the switching transistors are located.

9. The driving method according to claim 8, wherein the gate scan signals at different timings are generated by a plurality of gate drivers, respectively.

10. The driving method according to claim 8, wherein the gate scan signals at different timings are generated by a gate scan signal generation circuit, wherein the gate scan signal generation circuit comprises a gate driver and a plurality of switching elements which output the gate scan signals under the control of scan switching signals.

11. A display device, comprising:
a pixel array comprising sub-pixels arranged in rows and columns; and
a pixel driving circuit for driving the pixel array and comprising:
a source driving circuit providing data signals to each of the sub-pixels in the pixel array; and
a gate driving circuit providing gate scan signals to each of the sub-pixels in the pixel array;
wherein the gate driving circuit provides the gate scan signals at different timings to the sub-pixels in a repeating unit of the pixel array, respectively, and the repeating unit comprises at least one pixel unit comprising adjacent sub-pixels of different colors in the same row.

12. The display device according to claim 11, wherein the pixel driving circuit further comprises:
a plurality of data signal drivers disposed between the source driving circuit and the pixel array, each the data signal drivers having an input terminal and an output terminal;
wherein the input terminal of each of the plurality of data signal drivers is connected to the source driving circuit via a source line, and the output terminal of each of the plurality of data signal drivers is connected to the sub-pixels in the pixel array via data lines to transmit the data signals to the sub-pixels at different timings.

13. The display device according to claim 12, wherein the pixel driving circuit further comprises:
a timing control circuit providing data switching signals to the data signal drivers;
wherein each of the plurality of data signal drivers further has a control terminal connected to the timing control circuit, and whether the output terminals of the data signal drivers output the data signals or not is determined by the data switching signals input at the control terminals of the plurality of data signal drivers.

14. The display device according to claim 13, wherein each of the plurality of data signal drivers comprises:
a multiplexer having an input terminal connected to the source line and a plurality of output terminals; and
a plurality of first switching elements, each of which has an input terminal connected to a corresponding output terminal of the multiplexer, a control terminal receiving a corresponding data switching signal, and an output terminal connected to a corresponding data line to transmit the data signals to sub-pixels in the pixel array via the data line.

15. The display device according to claim 11, wherein the pixel unit comprises M sub-pixels, and the gate driving circuit provides N gate scan signals to N sub-pixels in the repeating unit at different timings, respectively, where M and N are positive integers, and N is an integral multiple of M.

16. The display device according to claim 15, wherein the N gate scan signals are generated by N gate drivers, respectively, and an output terminal of any one of the N gate drivers outputs one of the gate scan signals.

17. The display device according to claim 15, wherein the N gate scan signals are generated by a gate scan signal generation circuit which comprises:
a gate driver having an input terminal and N output terminals; and
N second switching elements, each of which has an input terminal connected to a corresponding output terminal of the gate driver, a control terminal receiving a scan switching signal, and an output terminal outputting a corresponding one among the gate scan signals under the control of the scan switching signal.
